(19) United States
(12) Patent Application Publication
(10) Pub. No.: US 2013/0005862 A1
(43) Pub. Date: Jan. 3, 2013

(54) DISPERSANT

(76) Inventors: Klaus Prosiegel, Trostberg (DE); Johann Goldbrunner, Garching (DE)

(21) Appl. No.: 13/511,760

(22) PCT Filed: Oct. 26, 2010
(86) PCT No.: PCT/EP2010/066148

§ 371 Date: Aug. 13, 2012

(30) Foreign Application Priority Data
Nov. 25, 2009 (EP) 09177093.3

(51) Int. Cl. C08L 33/02; C04B 24/26; C08K 3/30

(52) U.S. Cl. 524/5; 524/423

(57) ABSTRACT

A dispersant composition for construction compositions.

The present invention relates to the use of a composition having a dispersing effect and based on a polycarboxylate ether as a plasticizer for calcium sulphate-containing construction material mixtures in the form of screeds or thin layer levelling compounds.

The use of copolymers based on a polycarboxylate ether as plasticizers for construction chemistry materials, i.e. hydraulically setting and hardened compositions is sufficiently well known. Such copolymers substantially comprise an olefinic unsaturated monocarboxylic acid comonomer and an ester or a salt thereof and/or an olefinic unsaturated sulphonic add comonomer on the one hand and a comonomer having an ether function on the other hand. Such copolymers are described in more detail, for example, in EP 0 537 870 A1, EP 0 736 553 B1 EP 1 138 698 A1, EP 1 189 955 B1 and EP 1 902 085 B1.

The use of such copolymers as plasticizers is of interest not only for cementitious systems but especially also for calcium sulphate-based systems.

Both calcium sulphate and cements are binders hardening by hydration. The most well known representative of the calcium sulphate-based systems is gypsum, which is also designated as calcium sulphate dihydrate, terra alba or plaster of Paris. The latter is also known as calcined gypsum, plaster, calcium sulphate semihydrate or calcium sulphate hemihydrate. In this form, approximately 0.5 molecule of water is associated with one molecule of calcium sulphate. In order to obtain the hemihydrate form, gypsum is calcined and about ¾ of the combined water is thus expelled.

Depending on the preparation process, calcium sulphate hemihydrate may form at least two crystal forms, namely α-calcined gypsum and/or β-calcined gypsum.

By addition of the hemihydrate form to water, the hemihydrate reacts with sufficient amounts of water and is converted into interpenetrating dihydrate crystals, with the result that the slurry hardens.

If gypsum-containing compositions are poured into moulds in order to obtain, for example, prefabricated components or used in the production of so-called sandwich-type plasterboards, or wallboards i.e. construction material products in which a sheet-like, hardened gypsum layer is covered on both sides by paper layers, or fiber glass sheets which are used, for example, for the panelling of interior rooms or the production of composite heat insulation systems, it is desirable if the three-dimensional products obtained are dimensionally stable, and it is for this reason that the mixing water used in the slurry has to be expelled at relatively high temperatures within a very short time. The result is a brief but strong thermal action on the green bodies, with the result that cracks and chipping often occur. Attempts to reduce the mixing water as far as possible were therefore made not only from points of view related to energy, the problem of insufficient flowability of the unhardened slurry, however, then occurring again.

As already indicated, attempts have therefore been made to mix dispersants, which are also designated as plasticizers, with the slurry. These polymeric plasticizers coat the surfaces of the binder components and thus result in greater flowability of the particles in the wet composition, with the result that considerable amounts of mixing water can be saved.

However, the reduction in the amount of water also has the effect that the hardened products obtained have increased strength and density. A further advantage is to approximate the water-gypsum values of the expensive α-form by the addition of copolymers based on polycarboxylates to the preferred and much more economical β-form.

U.S. Pat. No. 7,338,990 B2 describes a mixture which contains cement and calcined gypsum and moreover a polycarboxylate dispersant. The dispersant is a copolymer based on an oxyalkylene glycol alkyl ether and unsaturated dicarboxylic acid derivatives. This mixture is used to produce outdoor products. However, their low strength and in particular early strength has proved to be disadvantageous. This effect is comparable with the known retarders of the type consisting of the fruit acids, such as, for example, tartaric acid and citric acid.

U.S. Pat. No. 7,056,964 B2 likewise describes a mixture which can be processed with a defined amount of mixing water to give a slurry which can be used as flooring material having a high strength. The mixture consists of a calcium sulphate hemihydrate, of which at least 25% must be present in the β-form, and a polycarboxylate plasticizer. The plasticizer is a copolymer of an oxyalkylene alkyl ether and an unsaturated dicarboxylic acid.

In the case of all levelling compounds which rely on polymeric plasticizers, the plasticizers are copolymers of three monomer subunits. The most well known building blocks are acrylic acid and acrylamide, maleic acid and so-called “VOBPEG” (vinyloxybutylpolyethylene glycol ether).

Arising from the disadvantages of the prior art, namely the substantial retardation of the setting and hardening behaviour due to the dicarboxylic acid fractions as comonomer, the object of the present invention is to provide alternative plasticizers which do not have this disadvantage and which, particularly, from economic points of view, constitute a useful alternative in the area of screeds and thin layer levelling compounds.

This objective was achieved by the use of a composition having a dispersing effect, containing a copolymer in the form of a polycarboxylate ether, consisting of
1) at least one olefinically unsaturated monocarboxylic acid comonomer or an ester or a salt thereof and/or an olefinic unsaturated sulphonic acid comonomer or a salt thereof,
and
2) at least one comonomer of the general formula (I)

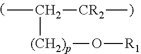

in which R₁ represents

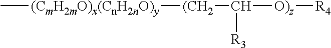

and R₂ represents H or an aliphatic hydrocarbon radical having 1 to 5 C atoms; R₃=an unsubstituted or substituted aryl radical and preferably phenyl, and R₄=H or an aliphatic hydrocarbon radical having 1 to 20 C atoms, a cycloaliphatic hydrocarbon radical having 5 to 8 C atoms, a substituted aryl radical having 6 to 14 C atoms or a representative of the series

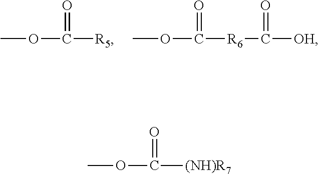

in which R₅ and R₇ each represent an alkyl, aryl, aralkyl or alkaryl radical and
R₆ represents an alkylidene, arylidene, aralkylidene or alkarylidene radical, and
p=0, 1, 2, 3 or 4
m, n, independently of one another, denote 2, 3, 4 or 5,
x and y, independently of one another, denote an integer 350 and
z=0 to 200,
(I) in copolymer a₁), the comonomer units which represent the components 1) and 2) having in each case no internal molecular differences and/or (II) the copolymer aₗ) representing a polymeric mixture of the components 1) and 2), in this case the comonomer units having internal molecular differences with regard to radicals R₁ and/or R₂ and/or R₃ and/or R₄ and/or R₅ and/or R₆ and/or R₇ and/or m and/or n and/or x and/or y and/or z and the differences discussed relating in particular to the composition and the length of the side chains,
   as plasticizers for calcium sulphate-containing construction material mixtures in the form of screeds or thin layer levelling compounds.

Surprisingly, it has been found that not only the objective could be completely achieved thereby in that the screeds and thin layer levelling compounds thus obtainable actually have a better early strength, with the result that the retarding effect can virtually be completely avoided. In the structural investigations, it was also found that the crystal habit of the hydraulic binder fractions was not affected. Moreover, improved processability and a lasting long-term stability of the hardened products were observable. Finally, the dispersants used can surprisingly be employed in a substantially lower dose in comparison with the plasticizers to date in the screed and thin layer levelling compounds sector, without adversely affecting the production conditions and the properties of the products thereby.

Said copolymers having only two comonomer units are disclosed in the abovementioned EP 1 902 085 B1, but they are not in relation to screeds or thin layer levelling compounds but exclusively in relation to gypsum systems.

Not least owing to the last-mentioned surprising advantage, the present invention, in a preferred embodiment, envisages using the plasticizers based on only 2 monomer units in an amount of 0.002 to 1.0% by weight and preferably 0.01 to 0.3% by weight of active substance, based in each case on the total composition of the construction material mixture. Amounts of 0.01 to 0.1% by weight of active substance are particularly preferred for systems based on α-hemihydrate form and amounts of 0.05 to 0.3% by weight of active substance are particularly preferred for systems based on β-hemihydrate form.

Particularly advantageous results can be obtained with screeds, but also with thin layer levelling compounds, which, according to the invention, contain 15 to 98% by weight, preferably 15 to 75% by weight and in particular 25 to 40% by weight, based in each case on the total composition of the construction material mixture, of calcium sulphate-based binder and in particular calcium sulphate hemihydrate and/or anhydrite.

The invention likewise envisages that the respective construction material mixtures also contain cements as hydraulic binders in addition to said proportions of gypsum. In this context, it is advisable to add 5% by weight and preferably between 2.0 and 5.0% by weight, once again based in each case on the total composition of the construction material mixture, of a cement to the screed composition or thin layer levelling compound. Preferably, cements such as Portland cement of the type OEM I, OEM II, OEM III, OEM IV and/or OEM V are suitable. However, white cements, high-alumina cements or mixtures of said cement forms are also suitable. Calcium hydroxide or other alkaline salts with hydraulic properties are preferably used.

In most applications, it may be advantageous to use the polycarboxylate plasticizer in dry form, preferably in powder form and particularly preferably in conglomerate-free form. Since the dispersant is processed predominantly simultaneously with the mixing water, it should preferably be used in water-soluble form, which is likewise envisaged by the present invention.

Regarding the polycarboxylate dispersant, there are in principle no limitations apart from the compulsory restriction to the two stated monomer units essential to the invention. All that is recommended is a molecular weight which is between 5000 and 100 000 dalton. Molecular weights between 10 000 and 80 000 are particularly preferred and those between 20 000 and 50 000 dalton are even more preferred.

The present invention furthermore envisages that the copolymer contains the comonomer component 1 in proportions of 30 to 99 mol % and the comonomer component 2 in proportions of 70 to 1 mol %. Preferred proportions regarding the comonomer component 1 are 40 to 90 mol % and regarding the comonomer component 2 are 60 to 10 mol %.

In the present case of the invention, the comonomer component 1 should represent an acrylic acid or a salt thereof and the comonomer component 2 with p=0 or 1 should contain a vinyl or allyl group and, as R₁, a polyether. In addition to the acrylic acid, however, methacrylic acid, crotonic acid, isocrotonic acid, allylsulphonic acid, vinylsulphonic acid and suitable salts thereof and the alkyl or hydroxyalkyl esters thereof are also suitable as comonomer component 1, where the alkyl radicals should have 1 to 10 C atoms.

it is also envisaged that the copolymer has additional structural groups in copolymerized form, apart from the two comonomer components 1 and 2. In this context, however, dicarboxylic acids are excluded. The additional structural groups may be styrenes, acrylamides and/or hydrophobic compounds, ester structural units, polypropylene oxide and polypropylene oxide/polyethylene oxide units being regarded as particularly preferred.

If the copolymer contains the additional structural groups, these should be present in proportions of up to 5 mol %, preferably from 0.05 to 3.0 mol % and in particular from 0.1 to 1.0 mol %.

Regarding the formula (I), the present invention envisages, in a preferred embodiment, that polyether containing allyl or vinyl groups is present.

Of course, in relation to its use in screeds and thin layer levelling compounds, the plasticizers according to the invention can also be used in combination with other dispersants. It is then entirely possible for these to contain unsaturated dicarboxylic adds and/or dicarboxylic add derivatives as comonomers. Through this measure, the performance of the plasticizers used can additionally be adapted to the respective intended use, but the respective production processes can also be optimized.

Owing to the advantageous properties of the copolymer described, the present invention comprises application variants which involve the production of screeds having a layer thickness of up to 10 cm and preferably up to 6 cm, but also of thin layer levelling compounds having a preferred layer thickness up to 20 mm. The screeds should in particular be based on a calcium sulphate-based binder and particularly preferably based on anhydrite and/or calcium sulphate hemihydrate and the thin layer levelling compounds should preferably be based on calcium sulphate hemihydrate.

In summary, it may be stated that, dispensing with dicarboxylic adds as a comonomer unit, the known plasticizers based on polycarboxylate ethers can be used in the form of copolymers based on only 2 comonomer units in nova/areas, which is advantageous in particular from economic points of view since the dose can be substantially reduced and moreover early strength values which lead to improved product properties are achieved.

The following examples illustrate the present invention.

1. Experiment with Different Plasticizers in a Standard Formulation for a Calcium Sulphate-Containing Screed

| Formulation: | | | | | Mixing procedure: | | | | | |
|---|---|---|---|---|---|---|---|---|---|---|
| 288.0 g of α-plaster (Knauf AGFF) | | | | | according to EN 196 Part I | | | | | |
| 699.37 g of standard sand | | | | | flow determined with Hägermann cone | | | | | |
| 12 g of CEM I 42.5 R | | | | | | | | | | |
| 0.5 g of Agitan P840 (defoamer) | | | | | | | | | | |
| 0.03 g of KelcoCrete DG-F (stabilizer) | | | | | | | | | | |
| 0.10 g of Retardan P (retarder) | | | | | | | | | | |
| 180 g of water | | | | | | | | | | |
| | Dry mortar | | | | | | | Flexural tensile | Compressive | |
| | test mix | | | | | | | strength | strength | Density |
| | WITHOUT | | | | Flow 5 | initial | final | 1d (dried | 1d (dried | 1d |
| | plasticizer | Water | Plasticizer | Plasticizer | min | set | set | specimen) | specimen) | dried |
| Plasticizer | [g] | [g] | [%/dry mortar] | [g] | [cm] | [h:min] | [h:min] | [N/mm²] | [N/mm²] | [kg/dm³] |
| Melflux 5581 F | 1000 | 180.0 | 0.0062 | 0.062 | 25.0 | 2:58 | 3:14 | 6.73 | 28.2 | 1.95 |
| (invention) | | | | | | | | | | |
| Melflux 1641F | 1000 | 180.0 | 0.0120 | 0.120 | 25.2 | 4:01 | 4:18 | 4.78 | 22.9 | 1.95 |
| (comparison 1) | | | | | | | | | | |
| Melflux 2651 F | 1000 | 180.0 | 0.0097 | 0.097 | 24.7 | 3:33 | 3:50 | 5.11 | 24.5 | 1.93 |
| (comparison 2) | | | | | | | | | | |

Melflux ® is a registered trade mark of BASF Construction Polymers GmbH

### 2. Comparison of Melflux 1641F, 2651F and Melflux 5581F in a Guide Formulation for Thin Layer Levelling Compounds

| | INVENTION | | Comparison 1 | | Comparison 2 | |
|---|---|---|---|---|---|---|
| | Melflux 5581 F | | Melflux 1641F | | Melflux 2651F | |
| Hemihydrate (alpha-form from FGD gypsum) | 400.00 | g | 400.00 | g | 400.00 | g |
| Quartz sand | 400.00 | g | 400.00 | g | 400.00 | g |
| (H33 from Quarzwerke Haltern) | | | | | | |
| Limestone filler (Omyacarb BG 20) | 173.20 | g | 172.57 | g | 173.09 | g |
| Retarder (Retardan P) | 0.035 | g | 0.035 | g | 0.035 | g |
| Stabilizer (Starvis 4500F) | 0.60 | g | 0.60 | g | 0.60 | g |
| Plasticizer (as stated) | 0.17 | g | 0.80 | g | 0.28 | g |
| Redispersable powder (Vinnapas 5011L) | 25.00 | g | 25.00 | g | 25.00 | g |
| Defoamer (Agitan P840) | 1.00 | g | 1.00 | g | 1.00 | g |
| Water | 200 | g | 200 | g | 200 | g |

| | | | |
|---|---|---|---|
| Flow (2 min) [cm] | 25.4 | 24.0 | 25.4 |
| Initial set (Vicat 300 g): [h:min] | 01:26 | 03:54 | 03:58 |
| Final set (Vicat 300 g): [h:min] | 01:30 | 03:59 | 04:16 |

1) Dry-mix solids
2) Add water
3) 1 min mixing with electric hand mixer
4) Determine Vicat flow (requirement 24.0-25.5 cm)
Melflux ® is a registered trade mark of BASF Construction Polymers GmbH

3. Experiments with Different Plasticizers in a Formulation for Calcium Sulphate Screed (CAF) with Thermal Anhydrite

| Formulation: | | | | | | | Mixtures: | | | | | |
|---|---|---|---|---|---|---|---|---|---|---|---|---|
| 675 g of thermal anhydrite | | | | | | | according to EN 196 Part I | | | | | |
| 1350 g of standard sand | | | | | | | flow determined with Hägermann cone | | | | | |
| 5 g of potasium sulphate (technical grade) | | | | | | | | | | | | |
| 20 g of CEM I 42.5 R | | | | | | | | | | | | |
| 1 g of Defoamer (Agitan P 840) | | | | | | | | | | | | |
| 328 g of water (water/solid = 0.16) | | | | | | | | | | | | |
| | Solid | | | | | | | | | | | |
| | WITH- | | Plasti- | | | | | | Surface | Flexural | Compres- | |
| | OUT | | cizer | Plasti- | Flow | Fresh | initial | final | hardness | tensile | sive | Density |
| | plasticizer | Water/ | [%/dry | cizer | 5 min | density | set | set | Shore D | strength | strength 1d | 1d |
| Plasticizer | [g] | solid | mortar] | [g] | [cm] | [kg/dm³] | [h:min] | [h:min] | after 24 h | 1d [N/mm³] | [N/mm³] | [kg/dm³] |
| Melflux 5581 F | 2051 | 0.160 | 0.0120 | 0.246 | 23.1 | 2.21 | 5:43 | 6:47 | 75 | 3.17 | 24.7 | 2.15 |
| (invention) | | | | | | | | | | | | |
| Melflux 1641F | 2051 | 0.160 | 0.0230 | 0.472 | 22.5 | 2.22 | 6:30 | 8:24 | 63 | 2.82 | 18.6 | 2.16 |
| (comparison 1) | | | | | | | | | | | | |
| Melflux 2651 F | 2051 | 0.160 | 0.0145 | 0.297 | 23.5 | 2.22 | 7:58 | 8:35 | 60 | 2.46 | 14.8 | 2.16 |
| (comparison 2) | | | | | | | | | | | | |

Melflux ® is a registered trade mark of BASF Construction Polymers GmbH

1-17. (canceled)

18. A method comprising adding a sufficient amount of a composition containing a copolymer in the form of a polycarboxylate ether and having a dispersing effect to a calcium sulphate-containing material to plasticize the composition and form a construction material, wherein the composition comprises:
1) at least one member selected from the group consisting of an olefinic unsaturated monocarboxylic acid comonomer, an ester of the olefinic unsaturated monocarboxylic acid comonomer, a salt of the olefinic unsaturated monocarboxylic acid comonomer, an olefinic unsaturated sulphonic acid comonomer and a salt of the an olefinic unsaturated sulphonic acid comonomer;
and
2) at least one comonomer of formula (I) 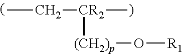
wherein R₁ is 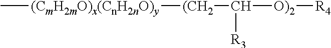
and R₂ represents H or an aliphatic hydrocarbon radical having 1 to 5 C atoms; R₃=an unsubstituted or substituted aryl radical and preferably phenyl, and R₄=H or an aliphatic hydrocarbon radical having 1 to 20 C atoms, a cycloaliphatic hydrocarbon radical having 5 to 8 C atoms, a substituted aryl radical having 6 to 14 C atoms or a representative of the series 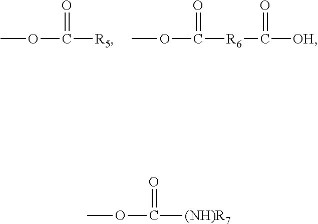
wherein R₅ and R₇ each are alkyl, aryl, aralkyl or alkaryl;
R₆ is alkylidene, arylidene, aralkylidene or alkarylidene,
p is 0, 1, 2, 3 or 4;
m and n are independently of one another 2, 3, 4 or 5;
x and y, independently of one another, are an integer≦350; and
z=0 to 200;
wherein (1) in copolymer a₁), the comonomer units which represent the components 1) and 2) have no internal molecular differences or (II) the copolymer a₁) is a polymeric mixture of the components 1) and 2), in this case the comonomer units having internal molecular differences with regard to radicals R₁ and/or R₂ and/or R₃ and/or R₄ and/or R₅ and/or R₆ and/or R₇ and/or in and/or n and/or x and/or y and/or z and the differences discussed relating in particular to the composition and the length of the side chains.

19. The method of claim 18, wherein the dispersant is present in an amount of 0.002 to 1.0% by weight, based on the total composition of the construction material.

20. The method according to claim 18, wherein the calcium sulphate binder is present in the construction material in an amount of from 15 to 98% by weight based on the total composition of the construction material.

21. The method according to claim 18, wherein the construction material comprises ≦50% by weight of a cement based on the total composition of the construction material.

22. The method according to claim 21, wherein the cement is selected from the group consisting of a Portland cement of the type CEM I, Portland cement of type CEM II, Portland cement of type CEM III, Portland cement of type, Portland cement of the type CEM IV and Portland cement of type CEM V, white cement, high-alumina cement and a sulphate-resistant cement.

23. A method according to claim 18, wherein the copolymer is in dry form.

24. A method according to claim 18, wherein the copolymer is used in water-soluble form.

26. A method according to claim 18, wherein the copolymer has a molecular weight between 5,000 and 100,000 dalton.

27. A method according to claim 18, wherein the copolymer contains the comonomer component 1) in an amount of from 0 to 99 mol % and the comonomer component 2) in an amount of from 70 to 1 mol %.

28. A method according to claim 18, wherein the copolymer contains the comonomer component 1) in an amount of from of 40 to 90 mol % and the comonomer component 2) in an amount of from of 60 to 10 mol %.

29. A method according to claim 18, wherein the comonomer component 1) is an acrylic acid or a salt thereof and the comonomer component 2) with p=0 or 1 contains a vinyl or allyl group and, as R₁ a polyether.

30. A method according to claim 18, wherein the comonomer component 1) originates from the group consisting of acrylic acid, methacrylic acid, crotonic acid, isocrotonic acid, allylsulphonic acid and vinylsulphonic acid, or suitable salts thereof and alkyl or hydroxyalkyl esters thereof.

31. A method according to claim 18, wherein the copolymer has additional structural groups in copolymerized form.

32. A method according to claim 31, wherein the additional structural groups are styrenes, acrylamides and hydrophobic compounds.

33. A method according to claim 32, wherein the copolymer contains additional structural groups in proportions of up to 5 mol %.

34. A method according to claim 18, wherein the formula (I) represents a polyether containing allyl or vinyl groups.

35. A method according to claim 18, wherein the compound is used in combination with other dispersants and in particular in combination with copolymers which contain unsaturated dicarboxylic acids and/or dicarboxylic acid derivatives as comonomers.

36. A method according to claim 18, wherein the construction composition is a screed having a layer thickness of up to 10 cm, or thin layer levelling compounds.
